(19) United States
(12) Patent Application Publication
(10) Pub. No.: US 2008/0083761 A1
(43) Pub. Date: Apr. 10, 2008

(54) Reservoir For Running Material

(75) Inventors: Martin Magnusson, Goteborg (SE); Sigurd Sonderegger, Askim (SE)

Correspondence Address: WRB-IP LLP, 1217 KING STREET, ALEXANDRIA, VA, 22314, US

(73) Assignee: VOLVO LASTVAGNAR AB, Göteborg (SE)

(21) Appl. No.: 11/720,341

(22) PCT Filed: Dec. 21, 2005
(86) PCT No.: PCT/SE05/02013

§ 371 Date: May 29, 2007

(30) Foreign Application Priority Data
Dec. 21, 2004 (SE) 0403154-8

(51) Int. Cl. B60K 15/03

(52) U.S. Cl. 220/562

(57) ABSTRACT

In a reservoir for running material, for example a fuel tank for a motor vehicle, a tank fitting is mounted in the tank, for example a fuel level meter. The upper end of the fitting is rigidly attached to the top wall of the tank, while its lower end is guided by guide elements, that allow limited movement of the lower end in a lateral direction. The guide elements are created of a cylindrical extension of a bottom plug that is screwed into a drainage opening in the tank and an element attached to the lower end of the tank fitting that has an opening, into which the cylindrical extension is inserted.

### BACKGROUND AND SUMMARY

The present invention relates to a reservoir for running material, for example a fuel tank for a motor vehicle, comprising a bottom wall, a top wall, side walls that connect the bottom wall with the top wall, fittings that extend through the interior of the reservoir from an area above the bottom wall down to the bottom wall and are attached to at least one of the walls of the bottom wall, a drainage opening that is made in the bottom wall and a bottom plug, by means of which the drainage opening can be closed.

In, for example, fuel tanks in motor vehicles there are almost always fittings in the form of fluid level meters, that send signals to a fuel gauge arranged in the cab of the vehicle. One type of level meter comprises a rod, that extends between the top wall and bottom of the tank and upon which a float is mounted in such a way that it can slide. The rod is normally suspended from the top wall. The lower end is usually at least partially guided in a lateral direction by guides that are attached to the bottom of the tank. Other types of fittings in tanks for running material are electrical heating coils, so-called immersion heaters, that, for example, are used in urea tanks for thawing the content when it has frozen. Also here it is the case that the electrical heating fitting should be fixed in relation to the tank bottom in such a way that a certain degree of movement in a lateral direction is possible.

In welded tanks, the guides are normally welded onto the bottom plate of the tank. In molded plastic tanks, the guides normally consist of profiles that are molded in one piece with the bottom of the tank. When such tanks are subjected to vibrations while the vehicle is being driven, a certain limited relative movement is allowed between the lower part of the level meter and the tank bottom. The movement is to be limited to be such that the upper attachment is not broken. If the lower end of the level meter is attached rigidly to the bottom, there is a risk that the attachment will vibrate apart and then the swinging movements of the fitting while the vehicle is being driven on an uneven surface could become so large that the upper attachment could break.

It is desirable to achieve a reservoir of the type described in the introduction, in which the need is eliminated for devices permanently attached to the bottom of the reservoir, which devices have the sole task of acting as guides for fittings.

According to an aspect of the invention by the bottom plug and the lower end part of the fitting are designed with interacting guide elements, that—when the bottom plug closes the drainage opening—at least partially limit the movement of the lower end part of the fitting in a lateral direction in relation to the bottom plug.

Accordingly, the invention discloses a reservoir for running materials, comprising a bottom wall, a top wall, side walls, that connect the bottom wall to the top wall, a drainage opening that is made in the bottom wall and a bottom plug, by means of which the drainage opening can be closed, fittings, that extend through the interior of the reservoir from an area above the bottom wall down to an area closed to the bottom wall and that are attached to one of the side walls of the bottom wall and/or the top wall, at which the bottom plug and the lower end part of the fittings are designed with interacting guide elements, at which one guide element is designed with an opening, into which a projecting part on the other guide element is inserted when the bottom plug closes the drainage opening and that—when the bottom plug closes the drainage opening—at least partially limit movement in a lateral direction of the lower end part of the fittings in relation to the bottom plug at which the guide elements are designed with interacting guide surfaces for centering the projecting part in the opening when the guide elements are moved towards each other. By giving an existing element, namely the bottom plug, an additional function such as the guiding of fittings, the cost of welding separate guides onto plate tanks or of the special construction of molds for plastic tanks can be eliminated.

In an aspect of the reservoir according to the invention, the bottom plug is designed with a cylindrical part that projects into the interior of the reservoir and into the existing circular opening in the fitting, which opening has a larger diameter than the said cylindrical part.

In a further aspect, the fitting has at its lower end an upwardly-narrowing conical recess with the said circular opening at its lower end. By this means, the assembly of fittings is made easier, as the side surfaces of the conical recess act as guide surfaces for centering of the cylindrical part of the bottom plug, when the fittings are lowered down into the reservoir from the top.

### BRIEF DESCRIPTION OF THE DRAWINGS

The invention will be described in greater detail with reference to embodiments shown in the attached drawings, in which

FIG. 1 shows a schematic perspective view of an embodiment of a reservoir according to the invention,

FIG. 2 shows a cross section through the reservoir in FIG. 1,

FIG. 3 shows an enlargement of the encircled area in FIG. 2 and

FIG. 4 shows a view corresponding to FIG. 2 of a modified embodiment of the invention.

### DETAILED DESCRIPTION

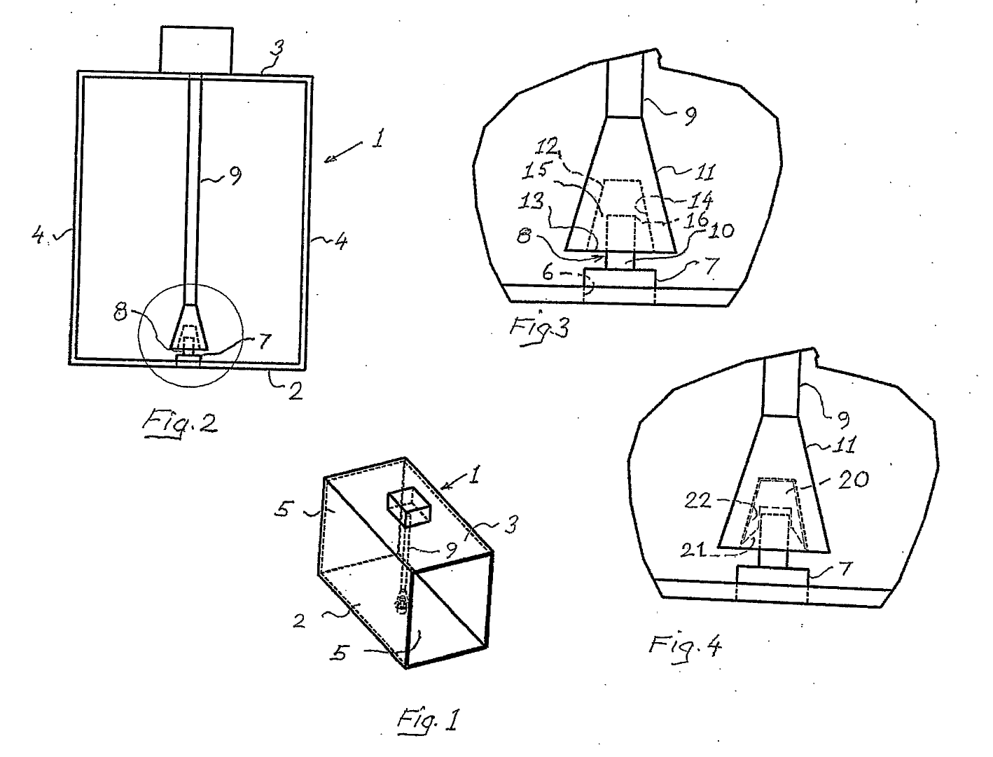

The reservoir 1 shown in FIG. 1 can be a fuel tank for a motor vehicle, that comprises a bottom wall 2, a top wall 3 and side walls 4 and 5, that connect the bottom wall 2 to the top wall 4. A threaded bottom plug 7 is screwed into a threaded drainage opening 6 in the bottom wall 2. The contents of the tank can be drained through the opening 6, for example when the tank is being cleaned. According to the invention, the bottom plug 7 is designed with a guide 8 for guiding in a lateral direction the lower end of a tank fitting 9, that is attached to the top wall 3 and that, for example, can be a fuel level meter and/or electrical heating coil. In the embodiment illustrated, the guide 8 is a cylinder 10 constructed in one piece with the plug 7 itself. As shown in FIG. 2, the lower part of the tank fitting 7 is designed with a part 11 that has a conical recess 12, into which the cylinder 10 projects when the plug 7 is screwed into the opening 6. As also shown, the conical recess 12 has an opening 13, the diameter of which is essentially larger than the diameter of the cylinder 10.

The function of the side wall 14 of the conical recess 12 is to make the insertion and centering of the cylinder 10 in the recess easier when lowering the fitting 9 into the interior of the reservoir. In its finally-mounted state, in the embodiment shown in FIGS. 2 and 3, there is a space 15 between the side wall 14 of the recess and the closest edge 16 of the cylinder 10. This space allows a certain degree of swinging movement of the fitting 9 when the vehicle is being driven on an uneven surface.

FIG. 4 shows an embodiment that differs from the embodiment described above only in that a bushing 20 that is made of flexible material and that has a conical recess 21 is arranged in the recess 12. The bushing 20 has an inner part 22, that, in the fitting's mounted position, fills the space 15 between the side wall 14 of the recess and the cylinder 10. The function of the bushing 20 is to damp the swinging movement of the fitting when the vehicle is being driven on an uneven surface.

The invention has been described above with reference to an embodiment in which the female part of the guide elements, that is the part 11 with the opening 13 and the bushing 20 (FIG. 4), is on the fitting, while the male part of the guide elements, that is the cylinder 10, is on the plug 7. It is, of course, possible within the framework of the invention to reverse the relationship and to have a flexible bushing on the male part of the guide element.

1. A reservoir, comprising a bottom wall, a top wall, a side connecting the bottom wall to the top wall, a drainage opening in the bottom wall and a bottom plug adapted to close the drainage opening, at least one fitting that extends through an interior of the reservoir from an area above the bottom wall down to an area proximate the bottom wall and that is attached to the side wall, the bottom plug and lower end part of the at least one fitting proximate the area having interacting guide elements, one guide element having an opening into which a projecting part on the other guide element is inserted when the bottom plug closes the drainage opening and when the bottom plug closes the drainage opening—at least partially limits movement in a lateral direction of the lower end part of the at least one fitting in relation to the bottom plug, wherein the guide elements have interacting guide surfaces for centering the projecting part in the opening when the guide elements are moved towards each other.

2. The reservoir as claimed in claim 1, wherein the opening and the projecting part define a space between side surfaces of the opening and of the projecting part that face towards each other.

3. The reservoir as claimed in claim 2, wherein flexible damping devices are inserted in the space.

4. The reservoir as claimed in claim 1, wherein one guide element is a part of the bottom plug that projects into the interior of the reservoir and the other guide element is a part attached to the lower end of the fitting with an opening that is matched to the projecting part.

5. The reservoir as claimed in claim 2, wherein one guide element is a part of the bottom plug that projects into the interior of the reservoir and the other guide element is a part attached to the lower end of the fitting with an opening that is matched to the projecting part.

6. The reservoir as claimed in claim 3, wherein one guide element is a part of the bottom plug that projects into the interior of the reservoir and the other guide element is a part attached to the lower end of the fitting with an opening that is matched to the projecting part.
